(19) United States
(12) Patent Application Publication
(10) Pub. No.: US 2015/0363900 A1
(43) Pub. Date: Dec. 17, 2015

(54) COMPUTER-READABLE RECORDING MEDIUM STORING PROGRAM FOR ASSISTING LICENSE MANAGEMENT, METHOD FOR ASSISTING LICENSE MANAGEMENT, AND DEVICE FOR SAME

(71) Applicant: FUJITSU LIMITED, Kawasaki-shi (JP)

(72) Inventors: Takuya Yasue, Nagoya (JP); Makoto Ikeyama, Nagoya (JP); Yuta Honda, Nagoya (JP)

(73) Assignee: FUJITSU LIMITED, Kawasaki (JP)

(21) Appl. No.: 14/736,826

(22) Filed: Jun. 11, 2015

(30) Foreign Application Priority Data
Jun. 17, 2014 (JP) 2014-124606

(51) Int. Cl. G06Q 50/18; G06Q 10/10

(52) U.S. Cl. CPC G06Q 50/184; G06Q 10/10

(57) ABSTRACT

A computer-readable recording medium having stored therein a program for causing a computer to execute a process for assisting license management, the process includes acquiring, from each of a plurality of computers, setting information for a software product which is installed in one of the plurality of computers; grouping the acquired setting information for each of the plurality of the software products based on contents of the each of the plurality of the software products; and urging to input a license type for each of at least some of a plurality of groups generated by the grouping for the each of the plurality of the software product.

### CROSS-REFERENCE TO RELATED APPLICATION

This application is based upon and claims the benefit of priority of the prior Japanese Patent Application No. 2014-124606, filed on Jun. 17, 2014, the entire contents of which are incorporated herein by reference.

### FIELD

The embodiment discussed herein is related to a technique for assisting software product license management.

### BACKGROUND

In software product license management, in order to provide protection from unauthorized use of software in view of compliance, the number of software products installed in each computer is totalized and the obtained total number is compared to the number of purchased licenses.

Conventionally, a single software product installed in each computer is managed as a single license, and therefore, license management may be performed by collecting a list of installed software.

In recent years, software license forms have been complicated and there are licenses in various forms. That is, there are cases where even a software product of a single type is licensed in a plurality of license forms. For example, the following license forms are known.

A. Preinstalled License

A license of software that was incorporated in advance at point of purchase of a computer. Licenses in this form include an original equipment manufacturer (OEM) license. Basically, a license in this form is provided free of charge, and therefore, is not managed.

B. Product License

A purchased software license. A license in this form is installed in a single computer and is thus usable.

C. Academic License

A license in this form is the same as a product license, but is usable in a package for educational institutions.

D. Suite License

In this form, use of each of packaged software products is allowed with a license with which suite software (that is, a software package) is purchased.

E. Client License

A license that allows use of a client product/function in software of a client server system. There are cases where licenses in this form include a central processing unit (CPU) (or CPU core) number license.

F. Sever License

A license that allows use of a server product/function in software of a client server system. There are cases where licenses in this form include a CPU (or CPU core) number license.

In view of security and protection from unauthorized use, information used for identification of a license form is not published from a vender that provides a software product, and is not possibly acquired from anywhere. Therefore, information used for determining a license form is not automatically collected from a computer that is an installation destination, and management of license forms in distinction from one another is not possible.

Japanese Laid-open Patent Publication No. 2001-222424 and Japanese Laid-open Patent Publication No. 2012-185536 discuss related art.

### SUMMARY

According to an aspect of the invention, a computer-readable recording medium having stored therein a program for causing a computer to execute a process for assisting license management, the process includes acquiring, from each of a plurality of computers, setting information for a software product which is installed in one of the plurality of computers; grouping the acquired setting information for each of the plurality of the software products based on contents of the each of the plurality of the software products; and urging to input a license type for each of at least some of a plurality of groups generated by the grouping for the each of the plurality of the software product.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an outline of a system according to an embodiment;

FIG. 2 is a function block diagram of a business server according to the embodiment;

FIG. 3 is a function block diagram of an operation management server;

FIG. 4 is a flow chart illustrating a flow of processing of a business server;

FIG. 5 is a table illustrating an example of a list of software products;

FIG. 6 is a table illustrating an example of product information;

FIG. 7 is a flow chart illustrating a flow of processing of an operation management server;

FIG. 8 is a flow chart illustrating a flow of receiving processing;

FIG. 9 is a table illustrating an example of data stored in a product information DB;

FIG. 10 is a flow chart illustrating a flow of grouping processing;

FIG. 11 is a table illustrating an example of data stored in a group information DB;

FIG. 12 is a table illustrating grouping processing;

FIG. 13 is a table illustrating an example of data stored in a group information DB;

FIG. 14 is a table illustrating contents of data stored in a group information DB, which has been updated;

FIG. 15 is a flow chart illustrating linking processing;

FIG. 16 is a table illustrating an example of data stored in a linking information DB;

FIG. 17 is a view illustrating an example of a screen displayed on an administrator terminal;

FIG. 18 is a view illustrating an example of a screen displayed on an administrator terminal;

FIG. 19 is a table illustrating a state of data stored in a linking information DB, which has been updated;

FIG. 20 is a table illustrating an example of data stored in a license data storage unit; and

FIG. 21 is a function block diagram of a computer.

### DESCRIPTION OF EMBODIMENT

As described in the background, information used for determining a license form is not automatically collected from a computer that is an installation destination, and management of license forms in distinction from one another is not possible. Accordingly, it is desired to provide an assisting technique that enables management in distinction of license forms of software products from one another.

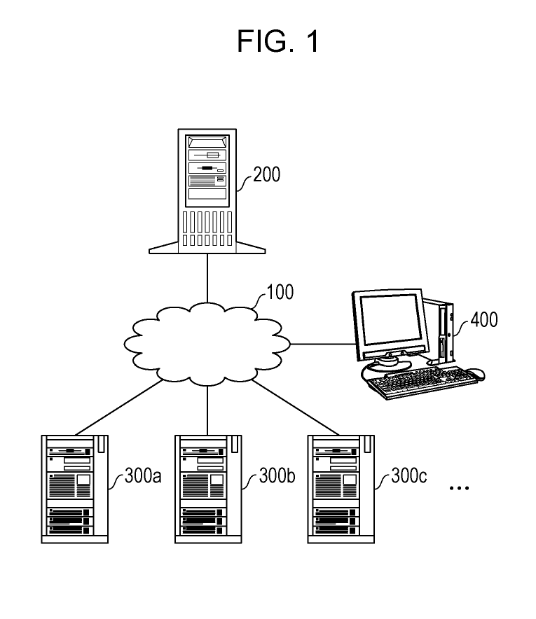

An outline of a system according to an embodiment of the present disclosure will be illustrated in FIG. 1. In the system according to this embodiment, an operation management server 200 that executes major processing according to this embodiment, a plurality of business servers 300 in which various types of software products are installed, and an administrator terminal 400 are coupled to a network 100, such as a local area network (LAN), and the like. The business servers 300a to 300c are depicted in FIG. 1, but the number of business servers is not limited.

There are cases where the business servers 300a to 300c are not servers but client terminals. The administrator terminal 400 is a terminal operated by a user who does license management business.

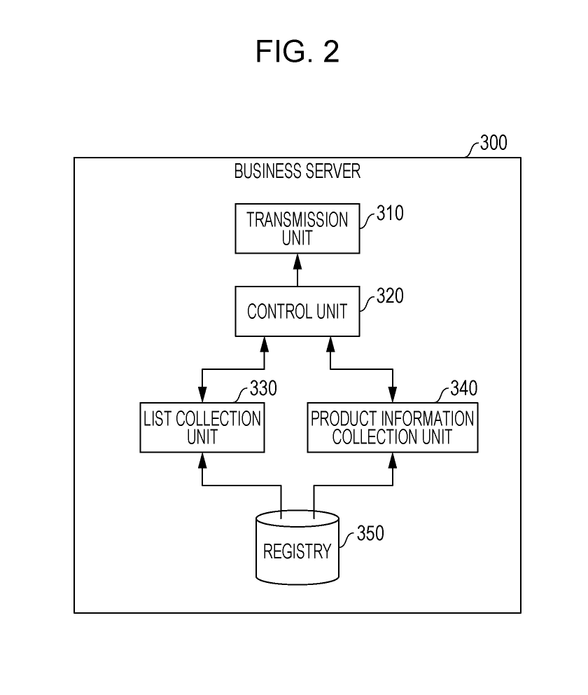

FIG. 2 depicts a function block diagram of the business server 300. The business server 300 includes a transmission unit 310, a control unit 320, a list collection unit 330, a product information collection unit 340, and a registry 350.

The registry 350 is system data which is managed by an operating system (OS) installed in the business server 300 and includes product information for a software product that is installed in the business server 300. The product information for an OS includes a plurality of combinations of a key, data, and a value. The product information is also represented as a combination of a setting item and a setting value.

The control unit 320 performs control of processing according to this embodiment in the business server 300. Specifically, the control unit 320 controls the transmission unit 310, the list collection unit 330, and the product information collection unit 340.

The list collection unit 330 collects a list of software products installed in the business server 300 from the registry 350, and outputs the list to the control unit 320, for example, in accordance with an instruction sent from the control unit 320. The product information collection unit 340 extracts product information from the registry 350 for each software product included in the list of software products and outputs the product information to the control unit 320 in accordance with an instruction sent from the control unit 320.

The transmission unit 310 transmits the product information for each software product with data of the server to the operation management server 200 in accordance with an instruction sent from the control unit 320.

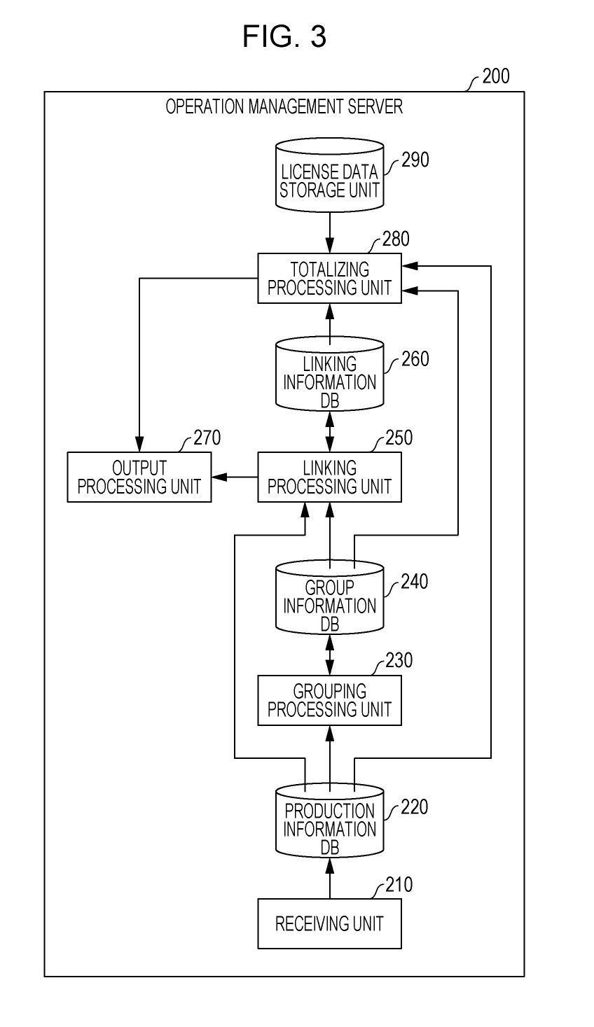

FIG. 3 is a function block diagram of the operation management server 200. The operation management server 200 includes a receiving unit 210, a production information DB 220, a grouping processing unit 230, a group information DB 240, a linking processing unit 250, a linking information DB 260, an output processing unit 270, a totalizing processing unit 280, and a license data storage unit 290.

The receiving unit 210 receives product information from each of the business servers 300a to 300c, and stores the product information in the production information DB 220. The grouping processing unit 230 performs grouping processing for the product information using data stored in the production information DB 220, and stores a processing result of grouping processing in the group information DB 240.

When a new group is detected for a specific software product, the linking processing unit 250 acquires data, such as a license type and the like, which is to be linked to the new group, from the administrator terminal 400 in cooperation with the output processing unit 270, and stores the data in the linking information DB 260.

The totalizing processing unit 280 totalizes the number of software products installed for each license type, and compares the number of software products to the number of licenses stored in the license data storage unit 290, and determines whether or not proper installation has been performed. There are cases where a determination result is output to the administrator terminal 400 via the output processing unit 270.

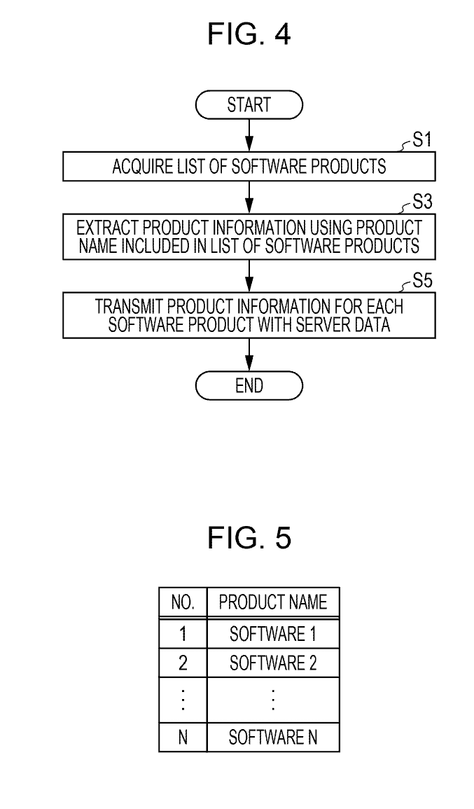

Next, processing contents of this system will be described with reference to FIG. 4 to FIG. 20.

First, contents of processing executed by each business server 300 will be described with reference to FIG. 4.

For example, when the control unit 320 of the business server 300 instructs the list collection unit 330 to perform processing regularly or at an arbitrary timing, the list collection unit 330 reads out data that indicates a list of software products from the registry 350 and outputs the data to the control unit 320 in accordance with the instruction (Step S1 in FIG. 4). For example, data illustrated in FIG. 5 is acquired.

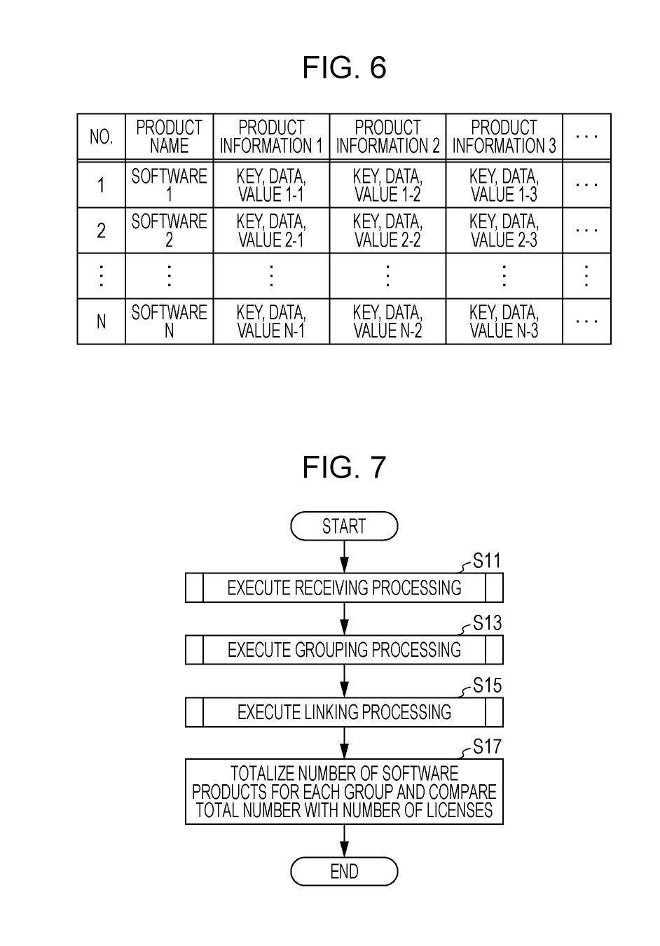

Then, the control unit 320 instructs the product information collection unit 340 to extract product information for each product name included in the list of software products, and the product information collection unit 340 extracts corresponding product information from a predetermined position of the registry 350 using the product name and outputs the corresponding product information to the control unit 320 in accordance with the instruction (Step S3). For example, data illustrated in FIG. 6 is extracted.

For example, a position in the registry 350 in which product information is stored is specified in advance for each OS, and the product information collection unit 340 extracts product information from the position. For example, as illustrated in FIG. 6, the product information includes a plurality of combinations of a key, data, and a value. The key is a key name (for example, HKEY_LOCAL_MACHINE\SOFTWARE|Version) of a registry, the data indicates a data name included in the key, and the value indicates a value set in the data.

For example, in the case of Windows (registered trademark), the position is under “HKEY_LOCAL_MACHINE\SOFTWARE”.

Then, the control unit 320 instructs the transmission unit 310 to transmit product information for each software product with server data of the business server 300 to the operation management server 200. The server data is a machine name, a management number, an IP address, an OS type, an administrator name, a setting place, and other data which are held in advance, for example. The transmission unit 310 transmits the server data and the product information for each software product to the operation management server 200 in accordance with the instruction (Step S5).

Next, processing contents of the operation management server 200 will be described with reference to FIG. 7 to FIG. 20.

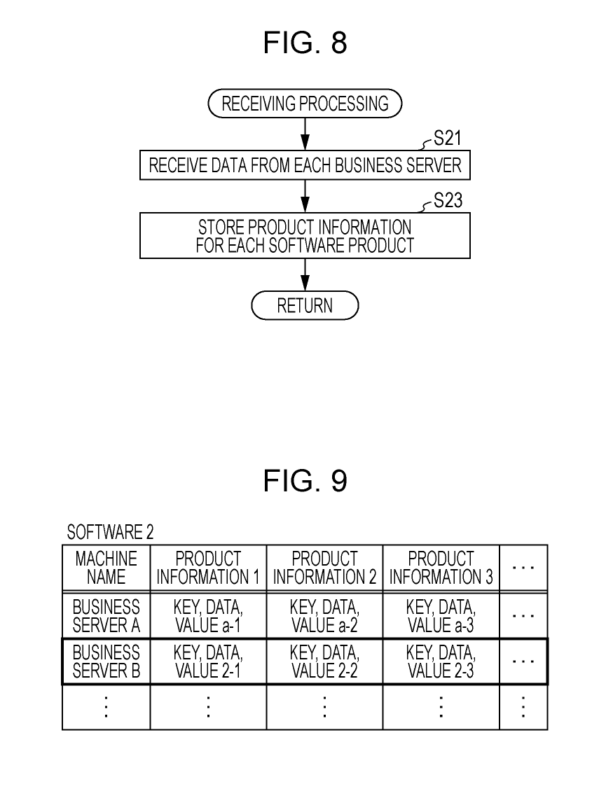

First, the receiving unit 210 of the operation management server 200 executes receiving processing (Step S11). Receiving processing will be described with reference to FIG. 8.

The receiving unit 210 receives product information for each software product from each business server 300 (Step S21). Then, the receiving unit 210 stores the product information in the production information DB 220 for each software product, specifically for the product name (Step S23). Note that the server data is also stored in the production information DB 220.

For example, when product information for each software product illustrated in FIG. 6 is transmitted from BUSINESS SERVER B with focus on a software product having, for example, a product name “SOFTWARE 2”, data illustrated in FIG. 9 is stored in the production information DB 220. In the example of FIG. 9, product information is registered in association with the machine name, and data indicated in a thick frame is data received from BUSINESS SERVER B.

Thus, product information for software products, which has been transmitted from the plurality of business servers 300 is aggregated for each software product, specifically, each product name.

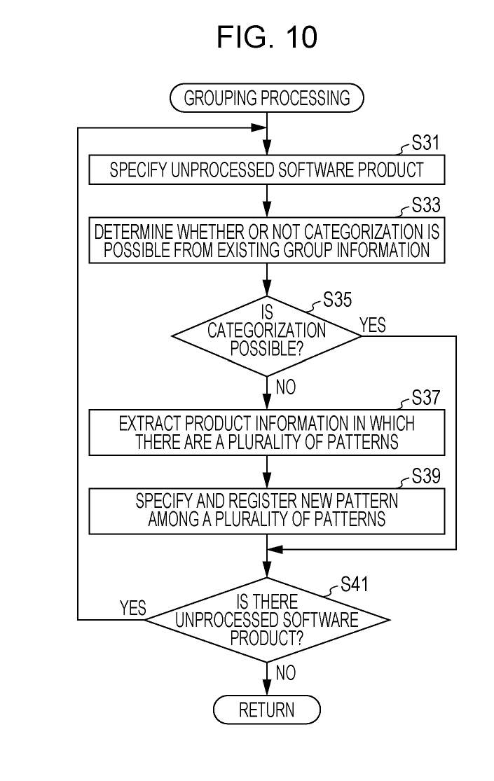

Returning to the description of the flow of processing of FIG. 7, next, the grouping processing unit 230 executes grouping processing (Step S13). Grouping processing will be described with reference to FIG. 10.

First, the grouping processing unit 230 specifies one unprocessed software product among software products for which product information is stored in the production information DB 220 (Step S31 in FIG. 10).

Then, the grouping processing unit 230 determines, based on existing group information (group information for a processing target software product) stored in the group information DB 240, whether or not a software product in each business server in which the processing target software product is installed is able to be categorized (Step S33).

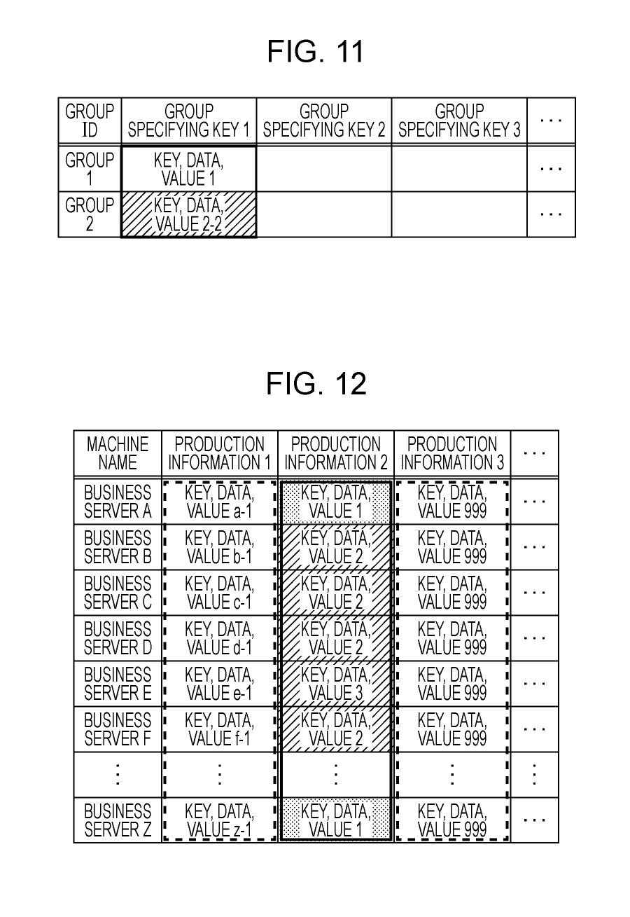

For example, it is assumed that group information illustrated in FIG. 11 is stored in the group information DB 240. In the example of FIG. 11, the group ID and one or more group specifying keys are registered for each group. In this example, one group specifying key is set and there are only two groups.

In Step S33, such group information has already existed in a processing target software, and it is determined whether or not a software product in each business server is able to be categorized by a group specifying key included in the group information. More specifically, whether or not product information illustrated in FIG. 9 in each business server matches any one of group specifying keys and whether or not there is product information that does not match any one of the group specifying keys.

In the example of FIG. 9, “KEY, DATA, VALUE 2-2” included in PRODUCT INFORMATION 2 of BUSINESS SERVER B is set as a group specifying key in GROUP 2 in FIG. 11. On the other hand, “KEY, DATA, VALUE a-2” included in PRODUCT INFORMATION 2 of BUSINESS SERVER A does not match the group specifying key of any group in FIG. 11. Therefore, the condition of Step S33 is not satisfied.

As described above, for software products that are able to be categorized using existing group information, the license forms of software products installed in the business servers 300a to 300c have not been changed, and therefore, processing is skipped as described below. Note that, initially, there is not group information, and therefore, it is determined that the condition of Step S33 is not satisfied.

When categorization is possible (YES in Step S35), the process proceeds to Step S41. On the other hand, when categorization is not possible (NO in Step S35), the grouping processing unit 230 extracts product information in which there are a plurality of patterns (that are less than the number of business servers), among product information for processing target software products, which are stored in the production information DB 220 (Step S37).

A specific example of Step S37 will be described with reference to FIG. 12. For processing target software products, when product information illustrated in FIG. 12 is acquired, the values for PRODUCT INFORMATION 1 for the business servers 300 all differ from one another. Using such product information, categorization of software products is not possible, and therefore, the product information is not employed as a group specifying key. The values for PRODUCT INFORMATION 3 in the business servers 300 are all the same. Using such product information, categorization of software products is also not possible, and therefore, the product information is not employed as a group specifying key.

For PRODUCT INFORMATION 2, only three patterns are stored, that is, a combination of KEY, DATA, and VALUE 1, a combination of KEY, DATA, and VALUE 2, and a combination of KEY, DATA, and VALUE 3. Since the number of business servers is 26, the number of patterns is less than the number of business serves, and thus, for PRODUCT INFORMATION 2, the product information may be employed as a group specifying key. Note that there are cases where a plurality of group specifying keys are extracted.

Then, the grouping processing unit 230 specifies a new pattern among a plurality of patterns by comparing the plurality of patterns to existing group information, and registers the new pattern in the group information DB 240 (Step S39).

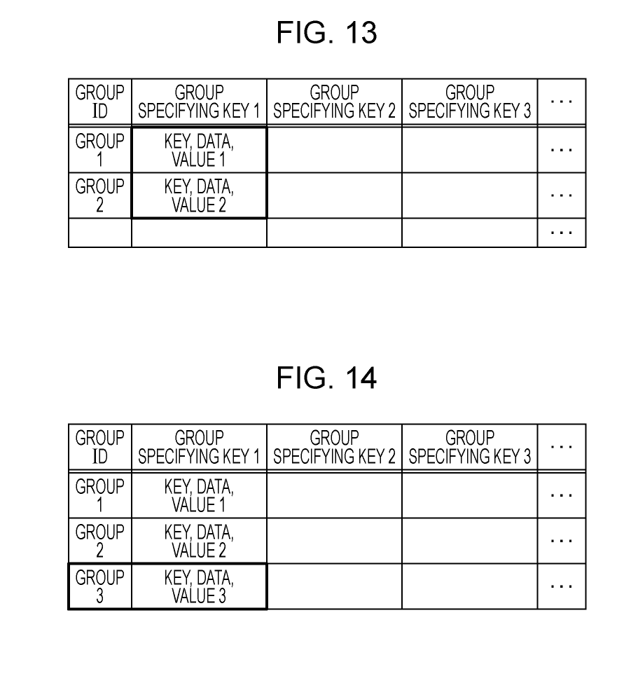

For example, as illustrated in FIG. 13, in a state where two groups are registered as group information in the group information DB 240, when three groups are extracted by the group specifying keys illustrated in FIG. 12, product information (“KEY, DATA, and VALUE 3” in the example of FIG. 12) that is not registered for the group specifying key is extracted and product information for a new group is additionally registered, as illustrated in FIG. 14. As for the group ID, a new group ID is generated from the group IDs that have been already registered.

Note that, when a plurality of group specifying keys are extracted in Step S37, a group is specified by combinations thereof. For example, when two patterns are extracted by a first group specifying key and two patterns are extracted by a second group specifying key, four groups in total are generated.

Thereafter, the grouping processing unit 230 determines whether or not there is an unprocessed software product in the production information DB 220 (Step S41). When there is an unprocessed software product, the process returns to Step S31. On the other hand, there is not an unprocessed software product, the process returns to processing of a caller.

Thus, for each software product, a group corresponding to a license type may be specified.

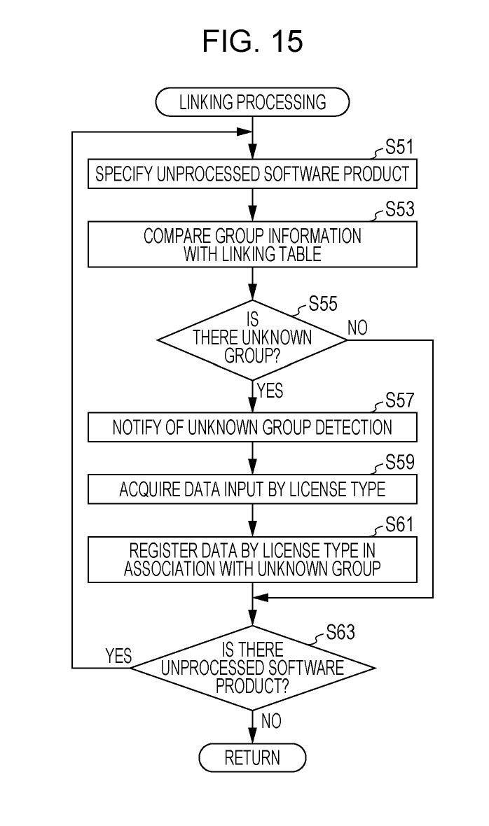

Returning to the processing of FIG. 7, next, the linking processing unit 250 executes linking processing (Step S15). Linking processing will be described with reference to FIG. 15.

First, the linking processing unit 250 specifies one unprocessed software product among software products for which group information is registered in the group information DB 240 (Step S51 in FIG. 15).

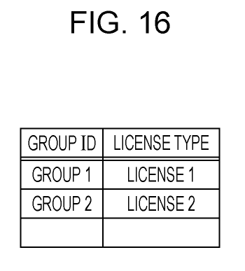

Then, the linking processing unit 250 compares group information for the specified software product and a linking table for the specified software product to each other (Step S53). FIG. 16 illustrates an example of the linking table for one software product. In the example of FIG. 16, the group ID and the license information are associated with each other. When the group information for the software product is the group information illustrated in FIG. 14, it is understood by comparing the linking table to the group information that the linking table lacks data of the group ID for “GROUP 3”.

Then, the linking processing unit 250 determines whether or not there is an unknown group that is registered in the group information but is not registered in the linking table (Step S55). When there is not an unknown group, the process proceeds to Step S63.

On the other hand, when there is an unknown group, in order to cause a user to input data of the license type, the linking processing unit 250 causes the output processing unit 270 to notify the user of unknown group detection (Step S57).

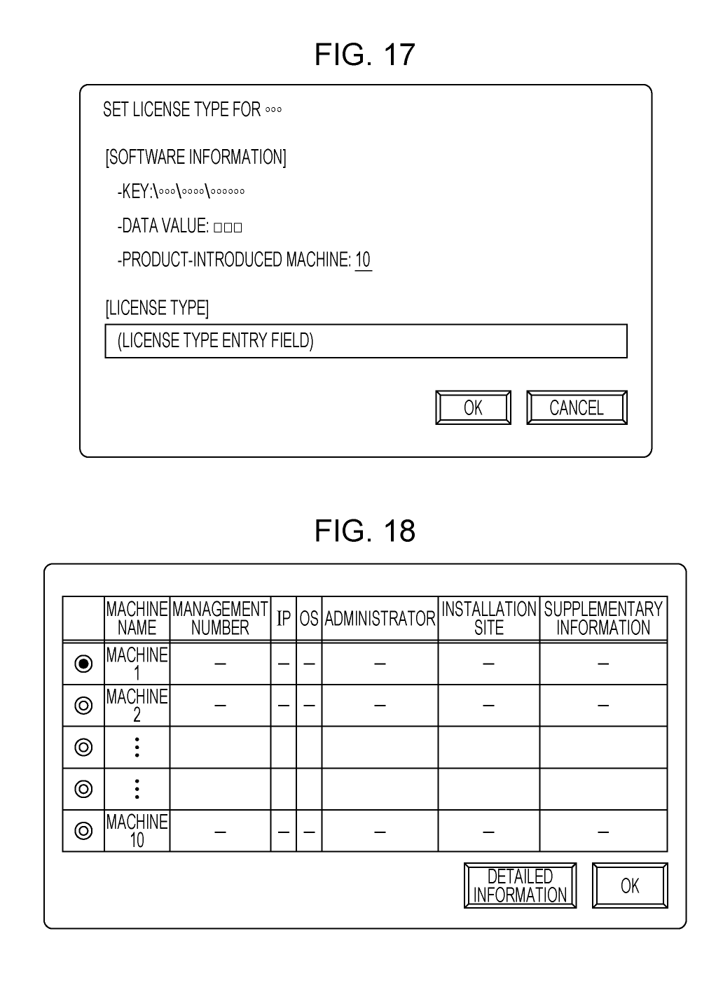

The output processing unit 270 performs search on the production information DB 220 using the product name of a processing target software product and a group specifying key included in group information for the unknown group, and extracts the corresponding business server 300. Thus, the number of the business servers 300 is also grasped. Then, for example, data of an input screen illustrated in FIG. 17 is generated and the generated data is output to the administrator terminal 400.

In the example of FIG. 17, as software information, the key of a group specifying key, the data value, and the number of machines in which a software product that belongs to the group is installed are included. The license type entry field is also provided as illustrated in FIG. 17.

In this example, the number of machines is a hypertext link and, when the number is clicked, data of the machines that are business servers may be displayed in a data list of the machines on another screen illustrated in FIG. 18.

In the example of FIG. 18, the machine name, the management number, the IP address, the OS type, the administrator name, the setting place, supplementary information, and the like are indicated for each machine. Furthermore, for each machine, a radio button is provided and, for the machine for which the radio button is on, more detailed information (for example, inventory information) may be displayed by clicking a detailed information button.

When a plurality of groups are detected, inputs for a plurality of groups may be made on one screen, and a screen may be changed for each group.

With reference to the above-described data, a user of the administrator terminal 400 inputs data of the license type for a newly detected group and causes the administrator terminal 400 to transmit the data to the operation management server 200.

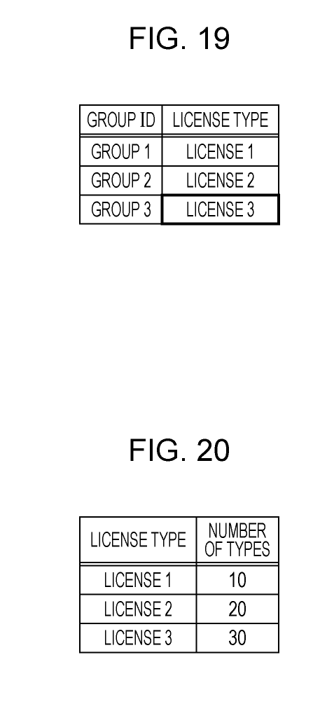

The output processing unit 270 receives data of the license type for the unknown group from the administrator terminal 400 and outputs the data to the linking processing unit 250 (Sep S59). The linking processing unit 250 registers the acquired data of the license type in association with the detected unknown group in the linking table for the processing target software product in the linking information DB 260 (Step S61). For example, in the case where there is the linking table illustrated in FIG. 16, when the license type of LICENSE 3 is acquired for GROUP 3, the table is changed to the state illustrated in FIG. 19.

Thereafter, the linking processing unit 250 determines whether or not there is an unprocessed software product among software products for which group information is registered in the group information DB 240 (Step S63). When there is an unprocessed software product, the process returns to Step S51. On the other hand, when there is not an unprocessed software product, the process returns processing of a caller.

Thus, even for software products having the same product name, the license type is registered for each group.

Returning to the description of the processing of FIG. 7, the totalizing processing unit 280 counts the number of software products that belong to each group (that is, a license) in the production information DB 220 based on the linking table and group information for each software product, and compares the number of software products to the number of licenses stored in the license data storage unit 290 (Step S17). For example, data illustrated in FIG. 20 is stored in the license data storage unit 290 for each software product (that is, for each product name). In the example of FIG. 20, the license type and the number of licenses are registered in association with each other.

The totalizing processing unit 280 determines whether or not there is a software product of which the number of installation is more than the number of licenses and outputs, when there is a software product of which the number of installation is more than the number of licenses, a warning to the administrator terminal 400 via the output processing unit 270. In this case, data of the license type associated with the software product name is presented.

When the above-described processing is performed, a software product that has been wrongly installed may be detected and a corrective measure may be taken.

By executing the above-described processing, even when software products have the same product name, a case where there are a plurality of types may be automatically detected. Then, when data, such as the license type, and the like, is set by a user, the license management of software products may be performed in a simple manner. That is, troublesome task of an administrator may be reduced.

Furthermore, a software product that has been totally newly installed may be automatically managed even when there is not a template.

An embodiment of the present disclosure has been described above, but the present disclosure is not limited thereto. For example, as for the processing flow, as long as a processing result does not change, the order of processes may be changed, and a plurality of steps may be executed in parallel.

Also, the function block configurations illustrated in FIG. 2 and FIG. 3 are merely examples, and there may be cases where a function block configuration is different from a program module configuration. Similarly, there may be cases where a data storage configuration is different.

The configuration of the display screen is merely an example, and various screens may be presented in different configurations.

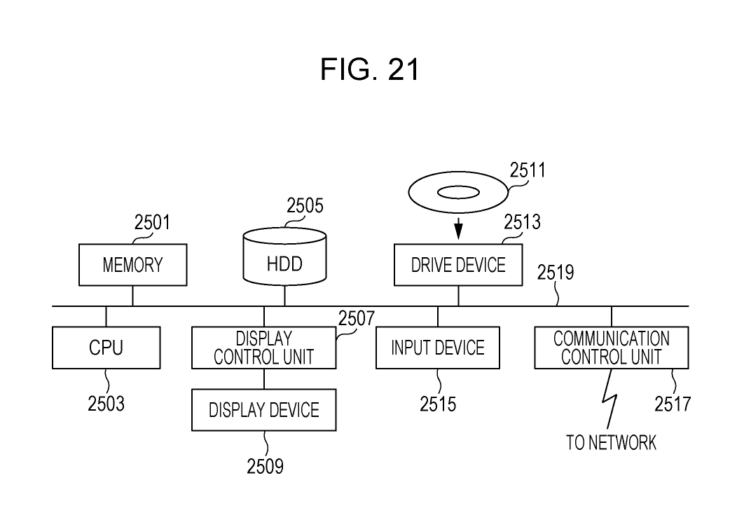

Note that the business server 300 and the operation management server 200 described above are computer devices and, as illustrated in FIG. 21, a memory 2501, a central processing unit (CPU) 2503, a hard disk drive (HDD) 2505, a display control unit 2507 coupled to a display device 2509, a drive device 2513 for a removal disk 2511, an input device 2515, and a communication control unit 2517 used for providing connection to a network are coupled together via a bus 2519. An operating system (OS) and an application program used for implementing the processing in this embodiment are stored in the HDD 2505 and, when being executed by the CPU 2503, the OS and the application programs are read out from the HDD 2505 to the memory 2501. The CPU 2503 controls the display control unit 2507, the communication control unit 2517, and the drive device 2513 in accordance with processing contents of the application program to cause each of the display control unit 2507, the communication control unit 2517, and the drive device 2513 to perform a predetermined operation. Also, half-processed data is mainly stored in the memory 2501, but may be stored in the HDD 2505. In this embodiment, an application program used for implementing the above-described processing is stored in a computer-readable removable disk 2511, is thus distributed, and then, is installed in the HDD 2505 from the drive device 2513. There are cases where such an application program is installed in the HDD 2505 via a network, such as the Internet, and the like, and the communication control unit 2517. The computers realize the above-described various types of functions by organic cooperation of hardware, such as the above-described CPU 2503, the memory 2501, and the like, and a program, such as an application program.

The above-described embodiment will be summarized as follows.

A license management assisting method according to this embodiment includes (A) acquiring, from each of a plurality of computers, setting information for a software product installed in the computers, (B) grouping, based on contents of setting information, the setting information acquired from each of the plurality of computers for each software product, and (C) urging a user to input a license type for at least some of a plurality of groups generated by the grouping for each software product.

Thus, when there are a plurality of derivative types even for the same software product, automatic detection is enabled, and thus, a license type may be set for each software product. Thus, troubles of license management may be reduced.

Note that the above-described processing of grouping may include (b1) extracting, among a plurality of setting items included in setting information, a setting item for which values of a plurality of types which are less than the number of computers in which the software product is installed, and (b2) categorizing, based on the values for the extracted setting item, a computer in which a software product is installed. A parameter that is usable for categorization may be properly extracted.

The license management assisting method may further include (D) storing the license type input by the user, the identifier of a group, and data used for specifying the group in a data storage unit in association with one another, and (E) determining, based on the data stored in the data storage unit and setting information for a software product, which has been acquired from one of the plurality of computers, whether or not the license type of the software product is able to be specified. For example, when an install status is regularly checked, when there is not any change, the checking may be performed in a simple manner.

Note that a program used for causing a processer or a computer to execute the above-described processing may be created, and the program is stored, for example, in an optical disk, such as a flexible disk, a CD-ROM, and the like, a magnetooptical disk, a semiconductor memory (for example, a ROM), a computer-readable storage medium, such as a hard disk, and the like, or a storage device. Note that, half-processed data is temporarily stored in a memory device, such as a RAM, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process for assisting license management, the process comprising:
acquiring, from each of a plurality of computers, setting information for a software product which is installed in one of the plurality of computers;
grouping the acquired setting information for each of the plurality of the software products based on contents of the each of the plurality of the software products; and
urging to input a license type for each of at least some of a plurality of groups generated by the grouping for the each of the plurality of the software product.

2. The non-transitory computer-readable recording medium having stored therein a program according to claim 1, wherein the grouping includes extracting a plurality of setting items included in the acquired setting information, each of the plurality of setting items including a value, the number of types of the values being less than the number of the plurality of computers, the plurality of computers including the installed software product corresponding to one of the plurality of setting items.

3. The non-transitory computer-readable recording medium having stored therein a program according to claim 1, the process comprising:
storing, in a data storage unit, the input license type, an identifier of one of the at least some of the plurality of groups, and data used for specifying the group in association with one another; and
determining, based on the data stored in the data storage unit and setting information for a software product, the setting information being acquired from one of the plurality of computers, whether or not the license type of the software product is able to be specified.

4. A license management assisting method that is executed by a computer, the method comprising:
acquiring, from each of a plurality of computers, setting information for a software product which is installed in one of the plurality of computers;
grouping the acquired setting information for each of the plurality of the software products based on contents of the each of the plurality of the software products; and
urging to input a license type for each of at least some of a plurality of groups generated by the grouping for the each of the plurality of the software product.

5. An information processing device comprising:
an acquiring unit configured to acquire, from each of a plurality of computers, setting information for a software product which is installed in one of the plurality of computers;
a grouping processing unit configured to group the acquired setting information for each of the plurality of the software products based on contents of the each of the plurality of the software products; and
an urging unit configured to urge to input a license type for each of at least some of a plurality of groups generated by the grouping for the each of the plurality of the software product.
